(19) United States
(12) Patent Application Publication
(10) Pub. No.: US 2002/0188749 A1
(43) Pub. Date: Dec. 12, 2002

(54) Receive performance of a network adapter by dynamically tuning its interrupt delay

(76) Inventor: Daniel R. Gaur, Beaverton, OR (US)

Correspondence Address: Lance A. Termes, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/876,921

(22) Filed: Jun. 6, 2001

(51) Int. Cl. G06F 15/16

(52) U.S. Cl. 709/234; 709/232

(57) ABSTRACT

Systems and methods for dynamically tuning the interrupt delay of a network adapter in response to variations in incoming network traffic loads. As incoming network traffic loads increase, the interrupt delay may be increased to permit an interrupt handler to “clean up” a greater number of packets with a single interrupt. Conversely, as incoming network traffic loads decrease, the interrupt delay may be decreased to expedite execution of the interrupt handler to “clean up” received packets. By monitoring incoming network traffic conditions, the duration of the interrupt delay of the network adapter can be optimized to efficiently receive incoming packets without excessive processor utilization and without poor response latency.

### TECHNICAL FIELD OF THE INVENTION

This disclosure relates to network adapters, and more particularly, but not exclusively, to apparatus and methods of improving the receive performance of a network adapter by dynamically tuning the network adapter's interrupt delay based on an evaluation of an incoming network load.

### BACKGROUND OF THE INVENTION

Physical devices interconnected in a computer system frequently utilize an interrupt as a mechanism for indicating the occurrence of certain events. An interrupt generally comprises a signal, transmitted from a device to a processor in the computer system, requesting attention from the processor. For example, a network adapter may generate, via a network controller, an interrupt, following successful transmission of a frame or upon receiving an incoming frame from a network. It will be understood by those skilled in the art that a frame generally comprises a packet of information transmitted as a unit in synchronous communications (hereinafter “frame” or “packet”).

A network adapter, also commonly referred to as a network interface card, comprises an expansion card, or similar device, used to provide network access to a computer system, or other device (e.g., a printer), and to mediate between the computer system and the physical media, such as cabling or the like, over which network transmissions (e.g., frames) travel. Typically, a network adapter, via the network controller, will generate a “receive interrupt” upon receiving a new frame from the network. This receive interrupt triggers the execution of an interrupt handler for processing the newly arrived frame, as well as other frames which may have arrived during a scheduling latency created as the processor completes its current tasks and switches contexts to execute the interrupt handler. The interrupt handler comprises a special routine that is executed when a specific interrupt occurs, and which includes instructions for dealing with the particular situation that caused the interrupt. The interrupt handler examines the network controller to determine the cause of the interrupt, for instance, the receipt of new frames from the network, and performs the necessary post-interrupt cleanup, which may include routing the incoming new frames to an appropriate application.

Each interrupt, and the execution of the interrupt handler, introduces an amount of “overhead” to the computer system's processor. The overhead comprises work or information that provides support for a computing process, but is not an intrinsic part of the operation or data. For example, with each incoming packet, the processor may need to send a signal, comprising the packet, over a bus, or otherwise transfer the packet to one or more other components of the computer system. This overhead may significantly impact processing time, especially in the context of modern operating systems, such as Windows NT®, or Windows® 2000.

Two distinct scenarios are presently utilized by network adapters, via the network controller, to signal the successful receipt of a new frame: (1) the network controller may generate an interrupt immediately following the receipt of a new packet; or (2) the network controller may delay the generation of an interrupt following the receipt of a new packet. The delay may be a set period of time, or it may be defined by the receipt of a pre-defined number of packets, or a fixed timeout period. By delaying generation of the interrupt, the network controller has an opportunity to receive additional frames before interrupting, thereby effectively “bundling” together several packets into a single interrupt. As a consequence of this “bundling,” the overhead associated with the interrupt is effectively amortized across several frames, thereby lessening the overhead to the computer system's processor. However, an additional consequence of incorporating a delay prior to generation of the interrupt, is that the average latency per packet is increased. Latency refers to the period of time that passes between a point in time at which a packet arrives at the network adapter from the network, and a point in time at which the interrupt handler is executed.

While delayed interrupts exhibit better system performance under heavy incoming network loads because multiple packets can be handled with the overhead of a single interrupt, immediate interrupts exhibit better system performance under light incoming network loads because each packet incurs a minimal latency, and the associated overhead of additional interrupts is not significant enough to degrade system performance.

Current devices, including network adapters, utilize a fixed policy for determining when to generate an interrupt. As mentioned previously, a network adapter may generate an interrupt, via the network controller, either immediately upon receiving a new frame, or the network adapter may introduce a delay before generating the interrupt. In either case, the interrupt policy is static, meaning that once the policy is initialized, the network adapter will continue to interrupt at a defined, fixed rate regardless of network or system conditions.

While a fixed interrupt scheme will always work, in the sense that the network adapter will carry out it's intended functions, such a fixed interrupt scheme cannot account for variations in the incoming network traffic density, or in the computer system. As such, a static interrupt policy may be optimized for a particular ideal workload, but as runtime workload shifts away from the ideal workload, the static policy may degrade overall system performance, thereby causing excessive processor utilization (e.g., if the network adapter interrupts too often), or poor response latency (e.g., if the network adapter delays the interrupts too long).

### BRIEF DESCRIPTION OF THE VARIOUS VIEWS OF THE DRAWINGS

In the drawings, like reference numerals refer to like parts throughout the various views of the non-limiting and non-exhaustive embodiments of the present invention, and wherein:

FIG. 1 is an illustration of an event timeline showing the occurrence of events in an example network environment in which incoming network traffic is relatively light;

FIG. 2 is an illustration of an event timeline showing the occurrence of events in an example network environment in which incoming network traffic is relatively heavy;

FIG. 3 is a flow diagram illustrating the implementation of an embodiment of the present invention; and

FIG. 4 is a graphical representation illustrating how the interrupt delay may vary in an example network environment as incoming network traffic fluctuates.

### DETAILED DESCRIPTION OF THE ILLUSTRATED EMBODIMENTS

Embodiments of a system and method for dynamically modifying the interrupt delay of a network adapter to optimize receive performance of the network adapter based on incoming network traffic are described in detail herein. In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, embodiments of the invention provide systems and methods for dynamically tuning the interrupt delay of a network adapter in response to an evaluation of incoming network traffic. In an embodiment, the network adapter, which may include a network controller, comprises a component of a computer system that may also include a processor and a device driver. The network adapter may be capable of being interconnected with the processor, and further capable of being connected to a network from which incoming network traffic may be generated.

In various embodiments, a scheduling algorithm adjusts duration of the interrupt delay based on, for example, the number of packets received in conjunction with a previous interrupt, or other suitable monitoring technique. As the duration of the interrupt delay is adjusted in response to incoming network traffic, the scheduling algorithm may also vary a pair of threshold values, corresponding to the upper and lower limits of the incoming network traffic load, for example, the number of packets per interrupt. These threshold values may then be utilized as a range for a future analysis of network traffic density, and a determination of when and how the interrupt delay should be adjusted to optimize performance and system efficiency. Other features of the illustrated embodiments will be apparent to the reader from the foregoing and the appended claims, and as the detailed description and discussion is read in conjunction with the accompanying drawings.

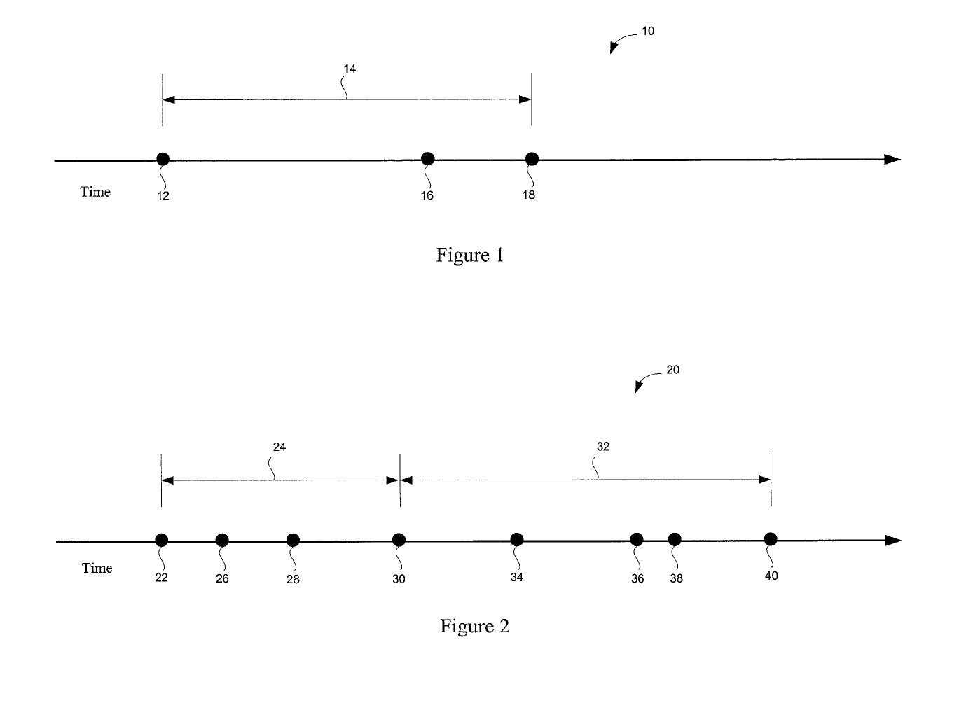

Referring now to the drawings, and in particular to FIG. 1, there is illustrated an event timeline generally at 10 showing the occurrence of example events in an example network environment in which incoming network traffic is relatively light. The reader will appreciate that the term “relatively” as used throughout this disclosure with reference to network traffic loads as being relatively light or relatively heavy is not intended to define any specific network traffic pattern or density, but is intended only to illustrate embodiments of the present invention. Network traffic that may be defined as relatively light in one instance, may be defined as relatively heavy in another.

In order to optimize efficiency in the computer system, and receive performance of the network adapter in a network environment, such as that illustrated in FIG. 1, the network controller will ideally interrupt after almost every packet received. By doing so, each incoming packet incurs only minor latencies, and the interrupts are too infrequent to substantially impact the performance of the processor, which may comprise a component of the computer system. For example, a first packet (i) arrives at a point in time on the event timeline, indicated by reference numeral 12. If, as illustrated in FIG. 1, the interrupt delay is set at zero, the network controller will generate an interrupt immediately upon receiving the first packet (i) (at reference numeral 12). Following the interrupt is a “scheduling latency,” indicated by reference numeral 14. The scheduling latency 14 corresponds to a length of time it takes the computer system's processor (e.g., microprocessor or digital signal processor) to complete its current tasks and switch contexts to execute the interrupt handler. The scheduling latency 14 may vary with the tasks being undertaken by the processor at the time the interrupt is generated.

In the example event timeline illustrated in FIG. 1, a second packet (i+1) arrives at a point in time on the event timeline, indicated by reference numeral 16, during the scheduling latency 14. At the point in time when the interrupt handler is executed (indicated by reference numeral 18), both the first packet (i) and the second packet (i+1) are “cleaned up” by the network adapter's device driver. The device driver comprises a software component that permits a computer system to communicate with a device, such as a network adapter, and which includes an interrupt handler for manipulating and handling incoming packets. Under network traffic conditions such as those illustrated in FIG. 1, an interrupt delay would typically only increase the packet latency, without any associated benefit in regard to bundling a number of packets together to be handled in a single interrupt.

Referring now primarily to FIG. 2, there is illustrated an event timeline generally at 20 showing the occurrence of example events in an example network environment in which incoming network traffic density is relatively heavy. In order to optimize efficiency in the computer system, and the receive performance of the network adapter under these network traffic conditions, the network controller will ideally interrupt after some defined period of delay, thereby allowing the computer system's processor and the device driver to handle a greater number of packets with the overhead of a single interrupt, while at the same time, only minimally affecting the latency of each incoming packet.

In the illustrated event timeline 20 of FIG. 2, a first packet 0) arrives at the network adapter at a point in time indicated by reference numeral 22. The arrival of this first packet (j) triggers the start of the interrupt delay, indicated by reference numeral 24, that precedes generation of the interrupt by the network controller (occurring at the point in time indicated by reference numeral 30). As illustrated in FIG. 2, two additional packets, (j +1) and (j+2), arrive at points in time along the event timeline 20, indicated by reference numerals 26 and 28 respectively. At the end of the interrupt delay (indicated by reference numeral 30), the network controller generates the interrupt, and the scheduling latency, indicated by reference numeral 32, begins in a manner similar to that described in conjunction with FIG. 1. As mentioned previously, the scheduling latency will not necessarily be identical for each corresponding interrupt, but may vary with the current tasks being undertaken by the computer system's processor at the time the interrupt is generated by the network controller.

During the scheduling latency 32, three additional packets, (j+3), (j+4), and (j+5), arrive at points in time along the event timeline 20, indicated by reference numerals 34, 36, and 38 respectively. At the point in time when the interrupt handler is executed (indicated by reference numeral 40), packets (j) through (j+5) are “cleaned up” by the network adapter's device driver. As the reader will appreciate from a comparison of FIGS. 1 and 2, assuming the scheduling latency to be identical in both situations, without the interrupt delay provided in FIG. 2, the network controller would have effectively missed packets (j+4) and (j+5) (indicated by reference numerals 36 and 38 respectively), and therefore would have had to interrupt the processor a second time to schedule and execute an interrupt handler to facilitate management of these last two packets.

In optimizing an interrupt schedule for the network adapter, competing interests, between interrupting too often, thereby leading to excessive processor utilization, and not interrupting often enough, thereby leading to poor response latency, may be considered. As the reader will appreciate from the foregoing discussion in conjunction with FIGS. 1 and 2, a virtually infinite range of network traffic loads may exist, and systems and methods that utilize static interrupt scheduling policies are unable to adequately cope with changing workloads.

Having observed the example network environments of FIGS. 1 and 2, and the distinct methods for efficiently handling the arrival of incoming network traffic under different network traffic loads, attention may now be given to systems and methods of the illustrated embodiments that facilitate the optimization of the network adapter's interrupt schedule by dynamically tuning the interrupt delay that precedes generation of the interrupt to signal the receipt of incoming network traffic. By adjusting the duration of the interrupt delay when, and as needed, the computer system of which the network adapter may be a component, may more efficiently handle incoming network traffic without excessive processor utilization, and without poor response latency.

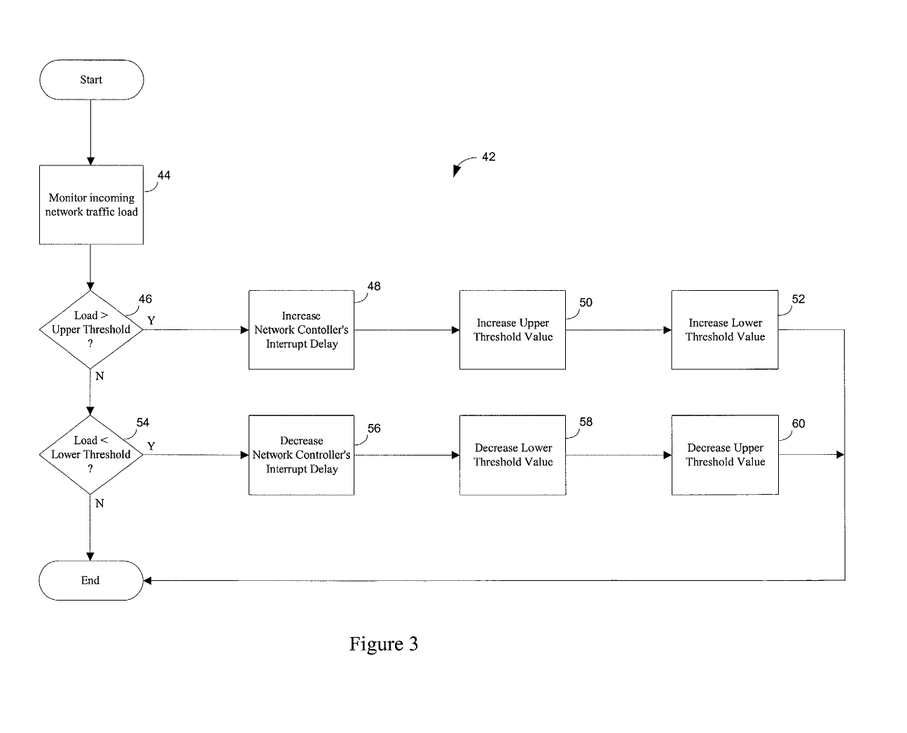

Turning our attention now primarily to FIG. 3, an interrupt scheduling process, illustrating the implementation of a scheduling algorithm in accordance with an embodiment of the invention, is depicted as a flow diagram generally at 42. The scheduling algorithm may be implemented as part of the device driver, or as a separate routine, executable by a controller, such as a microprocessor, a digital signal processor, or other device known to those skilled in the art. The reader will appreciate that the scheduling algorithm may be embodied as a set of instructions included on a machine-readable medium. A machine-readable medium includes any mechanism that provides (e.g., stores and/or transmits) information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier tones, infrared signals, and digital signals); and the like.

The embodiment illustrated by the process 42 generally comprises a method by which a network controller's interrupt delay is adjusted in response to a rate at which new packets are arriving from a network. The process 42 begins by monitoring the incoming network traffic load (see, e.g., reference numeral 44) to generate a monitoring input for use as a comparison tool in the remainder of the process 42. The monitoring input comprises a value corresponding to the incoming network traffic load. Monitoring the incoming network traffic load may be accomplished, in one embodiment, via the utilization of statistical counters that periodically examine the network controller to ascertain the rate of incoming packets. In other embodiments, the incoming network traffic load may be determined via a calculated number of packets being received per interrupt, or by other suitable systems and methods known to those skilled in the art.

Following monitoring of the incoming network traffic load (see, e.g., block 44), the monitoring input may be communicated to the device driver or other routine comprising the scheduling algorithm, and the process 42 proceeds to compare (see, e.g., block 46) the incoming network traffic load with an upper threshold. The upper threshold may be set at a value, in the first instance, by a system administrator based on an anticipation of incoming network traffic, or the upper threshold may be set at a predefined value upon system initialization. For example, the upper threshold may be set at a value between 64 and 512 packets per interrupt. It will be understood that this value may vary with the configuration of the network controller, the computer system with which the network controller may be implemented, and the incoming network traffic. As such, the values and ranges given herein are for illustrative purposes only, and should not be construed to limit the scope of the invention.

The reader will appreciate that the units (e.g., packets per interrupt), which define the value of the upper threshold, as well as a value corresponding to a lower threshold that will be discussed in greater detail hereinbelow, will correspond to the monitored incoming network traffic load. For example, if the incoming network traffic load is being monitored by the number of packets per interrupt, then the values of the upper and lower thresholds will also be defined by a number of packets per interrupt.

If the incoming network traffic load is greater than the value of the upper threshold, as determined by the comparison at block 46, then the process 42 proceeds to increase the network controller's interrupt delay (see, e.g., reference numeral 48). By increasing the interrupt delay, a greater number of incoming packets may be bundled together for processing via a single execution of the device driver's interrupt handler (see, e.g., FIG. 2), thereby enabling the computer system to spend more time processing other tasks, rather than repeatedly scheduling and servicing interrupt handlers.

Although the increase in the interrupt delay correspondingly increases the average latency per packet, the processor of the computer system may be able to more efficiently handle the rising workload without unduly burdening the system. In an embodiment of the invention, the interrupt delay may vary between 0 and 128 ms, and each increase in the interrupt delay may correspond to an increase of from 3 to 5 ms, for example. The interrupt delay may be set, in a first instance, by a system administrator based on an anticipation of incoming network traffic, or may be set at a predefined value upon-system initialization. The setting for the interrupt delay may be correlated to the initial settings for the upper and lower thresholds as well to create a range of network traffic loads corresponding to the duration of the interrupt delay.

After increasing the interrupt delay (see, e.g., block 48), the process 42 proceeds to increase the value of the upper threshold (see, e.g., reference numeral 50). As mentioned previously, the upper threshold may be set, in an embodiment, at a value within the range of 64 to 512 packets per interrupt, for example. An increase in the upper threshold may correspond to an increase of from 28 to 36 packets per interrupt, for example. Following the increase in the value of the upper threshold (see, e.g., block 50), the value of the lower threshold is also increased (see, e.g., reference numeral 52) by an amount that may be equal to the amount of the increase in the value of the upper threshold, for example. In other embodiments, the upper and lower thresholds may be increased by different amounts, and in still other embodiments, the upper threshold may be increased while the lower threshold remains unchanged. By increasing the value of both the upper threshold and the lower threshold by an equal amount, a defined range is maintained corresponding to a particular interrupt delay. When the rate of incoming network traffic falls outside of this range, then the interrupt delay may again be adjusted accordingly, and the upper and lower thresholds may once again be adjusted. Following adjustment of the value of the upper and lower thresholds, the process 42 ends, awaiting the next monitoring input.

Where the incoming network traffic load is less than or equal to the upper threshold, as determined by the comparison at block 46, the process 42 proceeds to compare (see, e.g., reference numeral 54) the incoming network traffic load with the lower threshold. As with the upper threshold discussed above, the lower threshold corresponds to a value that may vary, in an embodiment, between 64 and 512 packets per interrupt, for example, and may be set, in the first instance, by a system administrator or upon system initialization. Again, the value of the lower threshold will depend on the configuration of the network controller, the computer system with which the network controller may be implemented, and the incoming network traffic load. As such, the range of values set forth above should not be construed to limit the scope of the present invention.

If the incoming network traffic load is greater than or equal to the lower threshold (as determined by the comparison at block 54), then the process 42 ends, awaiting the next monitoring input. If the incoming network traffic load is less than the lower threshold (as determined by the comparison at block 54), then the process 42 proceeds to decrease the network controller's interrupt delay (see, e.g., reference numeral 56). By decreasing the interrupt delay (see, e.g., block 56), the computer system's processor and the device driver can handle the received packets more quickly, thereby decreasing the latency associated with each packet. The interrupt rate may be increased by this decrease in the interrupt delay, but the frequency of the interrupts may not be so great as to degrade system performance. In an embodiment of the invention, the interrupt delay may vary between 0 and 128 ms, while the decrease in the interrupt delay may correspond, in an embodiment, to a decrease of from 1 to 3 ms, for example.

After decreasing the interrupt delay at block 56, the process 42 proceeds to decrease the value of the lower threshold (see, e.g., reference numeral 58). As mentioned previously, the value of the lower threshold may, in an embodiment, be set within the range of 64 to 512 packets per interrupt, for example. The decrease in the value of the lower threshold (see, e.g., block 58) may, in an embodiment, correspond to a decrease of from 4 to 12 packets per interrupt, for example. Following the decrease in the value of the lower threshold at block 58, the value of the upper threshold may also be decreased (see, e.g., reference numeral 60) by an amount that may be equal to the amount of the decrease in the value of the lower threshold, for example. In other embodiments, the upper and lower thresholds may be decreased by different amounts, and in still other embodiments, the lower threshold may be decreased while the upper threshold remains unchanged. As with the increases in the values of the upper and lower thresholds discussed previously, by decreasing the value of both the lower threshold and the upper threshold by an equal amount, a defined range is maintained corresponding to a particular interrupt delay. When the rate of incoming network traffic falls outside of this range, then the interrupt delay may again be adjusted accordingly, and the lower and upper thresholds may once again be adjusted. Following adjustment of the lower and upper threshold values (at blocks 58 and 60 respectively), the process 42 ends, awaiting the next monitoring input.

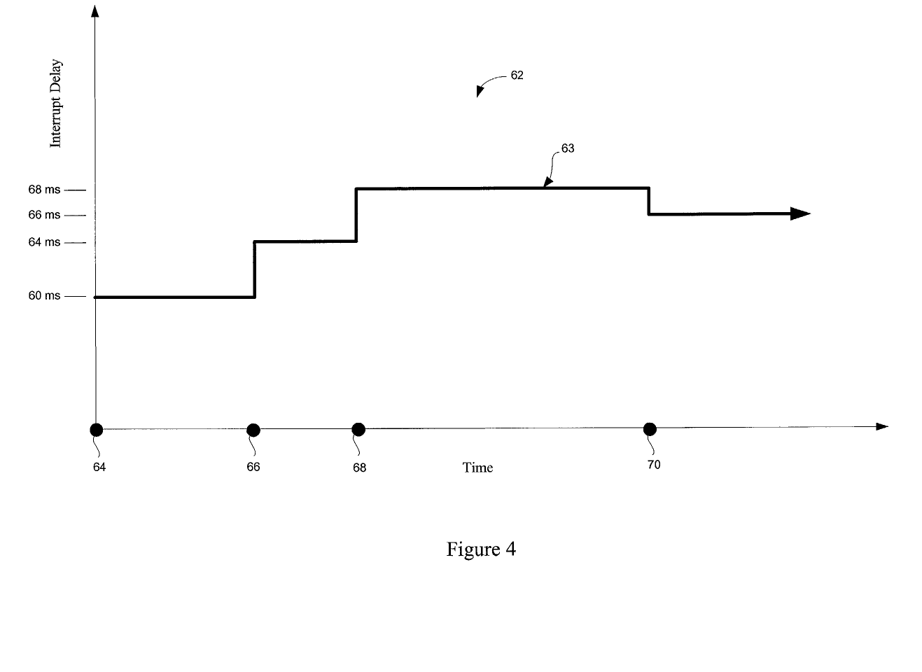

Referring now primarily to FIG. 4, a graphical representation illustrating how the interrupt delay may vary in an example network environment is shown generally at 62. In the example illustrated in FIG. 4, the interrupt delay (represented by the line having reference numeral 63) may be set at 60 ms, for example, at the point in time indicated by reference numeral 64. At this same point in time 64, the upper threshold may be set at 300 packets per interrupt, for example, and the lower threshold may be set at 268 packets per interrupt, for example. These values may be preset, as discussed previously in regard to FIG. 3, by a system administrator or upon system initialization, or may represent any point in time at which the interrupt delay, and the upper and lower thresholds have reached the given values in response to incoming network traffic conditions.

As time passes, a second point in time, indicated by reference numeral 66, is reached, wherein the incoming network traffic load in the example network environment has increased beyond the value of the upper threshold to, for example, 310 packets per interrupt. Because the incoming network traffic load has increased beyond the value of the upper threshold, the scheduling algorithm, an embodiment of which is described hereinabove with reference to FIG. 3, increases the interrupt delay by 4 ms, for example, to 64 ms, and increases the values of the upper and lower thresholds by, for example, 32 packets per interrupt, to 332 packets per interrupt and 300 packets per interrupt, respectively.

Continuing on the time line to the point in time indicated by reference numeral 68, the incoming network traffic load in the example network environment has again increased beyond the value of the upper threshold to, for example, 353 packets per interrupt. As with the previous response, the scheduling algorithm increases the interrupt delay by 4 ms, for example, to 68 ms, and increases the values of the upper and lower thresholds by, for example, 32 packets per interrupt, to 364 packets per interrupt and 332 packets per interrupt, respectively. Further continuing on the time line to the point in time indicated by reference numeral 70, the incoming network traffic load in the example network environment has decreased below the value of the lower threshold to, for example, 327 packets per interrupt. In response to this decreased workload, the scheduling algorithm decreases the interrupt delay by 2 ms, for example, to 66 ms, and decreases the values of the upper and lower thresholds by, for example, 8 packets per interrupt, to 356 packets per interrupt and 324 packets per interrupt. This process of adjustment may continue as the incoming network traffic load varies, thereby optimizing the receive performance of the network adapter and the efficiency of the computer system with which the network adapter may be interconnected.

It is possible that the incoming network traffic load may change so dramatically that the load, defined as packets per interrupt, for example, may remain above or below the value of the upper or lower threshold, respectively, even after an adjustment is made by the scheduling algorithm. For instance, in the example given above in regard to the point in time designated by reference numeral 70, had the incoming network traffic load decreased to 321 packets per interrupt, for example, the adjustment in the value of the lower threshold to 324 packets per interrupt would not have encompassed the monitored network traffic load. In such circumstances, assuming the level remains at a point below the lower threshold, then the scheduling algorithm will again adjust the interrupt delay and the values of the upper and lower thresholds in accordance with the previous examples. It will be appreciated that the example values given in the preceding discussion and figures are for illustrative purposes only, and should not be construed to limit the scope of the present invention beyond that which is expressly set forth in the claims.

While the invention is described and illustrated here in the context of a limited number of embodiments, the invention may be embodied in many forms without departing from the spirit of the essential characteristics of the invention. The illustrated and described embodiments, including what is described in the abstract of the disclosure, are therefore to be considered in all respects as illustrative and not restrictive. The scope of the invention is indicated by the appended claims rather than by the foregoing description, and all changes which come within the meaning and range of equivalency of the claims are intended to be embraced therein.

What is claimed is:

1. A method of improving the receive performance of a network adapter, the method comprising:
monitoring an incoming network traffic load; and
dynamically tuning an interrupt delay in response to the incoming network traffic load, wherein dynamically tuning the interrupt delay includes increasing the interrupt delay in response to an increase in the incoming network traffic load, and decreasing the interrupt delay in response to a decrease in the incoming network traffic load.

2. The method of claim 1, wherein dynamically tuning the interrupt delay includes comparing the incoming network traffic load with an upper threshold, and wherein the incoming network traffic load is greater than the upper threshold, increasing the interrupt delay.

3. The method of claim 1, wherein dynamically tuning the interrupt delay includes comparing the incoming network traffic load with a lower threshold, and wherein the incoming network traffic load is less than the lower threshold, decreasing the interrupt delay.

4. The method of claim 1, wherein monitoring the incoming network traffic load includes calculating a number of packets received per interrupt.

5. The method of claim 1, wherein monitoring the incoming network traffic load includes using a statistical counter to periodically examine a network controller.

6. The method of claim 1, wherein the interrupt delay may be dynamically tuned within the range of from about 0 milliseconds to about 128 milliseconds.

7. The method of claim 1, wherein increasing the interrupt delay corresponds to an increase of from about 3 milliseconds to about 5 milliseconds.

8. The method of claim 1, wherein decreasing the interrupt delay corresponds to a decrease of from about 1 millisecond to about 3 milliseconds.

9. A method of improving the receive performance of a network adapter, the method comprising:
monitoring an incoming network traffic load; and
dynamically tuning an interrupt delay in response to the incoming network traffic load, wherein dynamically tuning the interrupt delay includes increasing the interrupt delay when the incoming network traffic load is greater than an upper threshold, and decreasing the interrupt delay when the incoming network traffic load is less than a lower threshold.

10. The method of claim 9, wherein, when the interrupt delay is increased, the upper threshold is increased and the lower threshold is increased, and when the interrupt delay is decreased, the upper threshold is decreased and the lower threshold is decreased.

11. The method of claim 10, wherein the upper threshold and the lower threshold are increased or decreased by an equal amount.

12. The method of claim 10, wherein the upper threshold and the lower threshold are increased or decreased by different amounts.

13. An article of manufacture, comprising:
a machine-readable medium that provides instructions which, when executed by a machine, cause the machine to perform operations, the operations comprising:
monitoring an incoming network traffic load; and
dynamically tuning an interrupt delay in response to the incoming network traffic load, wherein dynamically tuning the interrupt delay includes increasing the interrupt delay in response to an increase in the incoming network traffic load, and decreasing the interrupt delay in response to a decrease in the incoming network traffic load.

14. The article of manufacture of claim 13, wherein dynamically tuning the interrupt delay includes comparing the incoming network traffic load with an upper threshold, and wherein the incoming network traffic load is greater than the upper threshold, increasing the interrupt delay.

15. The article of manufacture of claim 13, wherein dynamically tuning the interrupt delay includes comparing the incoming network traffic load with a lower threshold, and wherein the incoming network traffic load is less than the lower threshold, decreasing the interrupt delay.

16. The article of manufacture of claim 13, wherein monitoring the incoming network traffic load includes calculating a number of packets received per interrupt.

17. The article of manufacture of claim 13, wherein monitoring the incoming 0.14 network traffic load includes using a statistical counter to periodically examine a network controller.

18. The article of manufacture of claim 13, wherein the interrupt delay may be dynamically tuned within the range of from about 0 milliseconds to about 128 milliseconds.

19. The article of manufacture of claim 13, wherein increasing the interrupt delay corresponds to an increase of from about 3 milliseconds to about 5 milliseconds.

20. The article of manufacture of claim 13, wherein decreasing the interrupt delay corresponds to a decrease of from about 1 millisecond to about 3 milliseconds.

21. A computer system, comprising:
a processor;
a network adapter capable of being interconnected with the processor, and capable of being connected to a network, the network adapter including a network controller; and
a device driver capable of being executed by the processor; and wherein the device driver comprises instructions which, when executed by the processor, cause the computer system to perform operations, the operations comprising:
monitoring an incoming network traffic load from the network; and
dynamically tuning an interrupt delay that precedes an interrupt generated by the network controller in response to the incoming network traffic load, wherein dynamically tuning the interrupt delay includes increasing the interrupt delay in response to an increase in the incoming network traffic load, and decreasing the interrupt delay in response to a decrease in the incoming network traffic load.

22. The computer system of claim 21, wherein dynamically tuning the interrupt delay includes comparing the incoming network traffic load with an upper threshold, and wherein the incoming network traffic load is greater than the upper threshold, increasing the interrupt delay.

23. The computer system of claim 21, wherein dynamically tuning the interrupt delay includes comparing the incoming network traffic load with a lower threshold, and wherein the incoming network traffic load is less than the lower threshold, decreasing the interrupt delay.

24. The computer system of claim 21, wherein monitoring the incoming network traffic load includes calculating a number of packets received per interrupt.

25. A method of dynamically tuning a network adapter interrupt delay, the method comprising:
generating a monitoring input, the monitoring input comprising a value corresponding to an incoming network traffic load;
comparing the monitoring input with an upper threshold, and wherein the monitoring input is greater than the upper threshold, increasing the network adapter interrupt delay, and wherein the monitoring input is less than or equal to the upper threshold;
comparing the monitoring input with a lower threshold, and wherein the monitoring input is less than the lower threshold, decreasing the network adapter interrupt delay.

26. The method of claim 25, wherein, when the network adapter interrupt delay is increased, the upper threshold is increased and the lower threshold is increased, and when the network adapter interrupt delay is decreased, the upper threshold is decreased and the lower threshold is decreased.

27. The method of claim 25, wherein the network adapter interrupt delay may be dynamically tuned within the range of from about 0 milliseconds to about 128 milliseconds.

28. The method of claim 25, wherein the value comprises a calculation of a number of packets received per interrupt.
